(19) United States
(12) Patent Application Publication
(10) Pub. No.: US 2022/0198636 A1
(43) Pub. Date: Jun. 23, 2022

(54) INSPECTION DEVICE

(71) Applicant: DENSO CORPORATION, Kariya-city (JP)

(72) Inventors: Kazue ASANO, Kariya-city (JP); Motohiro SHIRAI, Kariya-city (JP)

(21) Appl. No.: 17/690,187

(22) Filed: Mar. 9, 2022

Related U.S. Application Data
(63) Continuation of application No. PCT/JP2020/034903, filed on Sep. 15, 2020.

(30) Foreign Application Priority Data
Oct. 16, 2019 (JP) 2019-189541

(51) Int. Cl. G06T 7/00

(52) U.S. Cl. CPC G06T 7/001; G06T 2207/30164; G06T 2207/30168

(57) ABSTRACT

An inspection device includes an imaging device attached to an operator to image an imaging range, and a determinator configured to determine a quality of an inspection object. The determinator is configured: to receive image data of the imaging range transmitted from the imaging device; to identify an image area in which the inspection object exists in the image data of the imaging range; to set a predetermined area within the image area in which the inspection object exists, as an inspection area; and to collate the image data of the inspection area with a pre-registered collation image data to determine whether the quality of the inspection object is defective or not. Therefore, it is possible to more accurately determine the quality of the inspection object to be inspected.

### CROSS REFERENCE TO RELATED APPLICATION

The present application is a continuation application of International Patent Application No. PCT/JP2020/034903 filed on Sep. 15, 2020, which designated the U.S. and claims the benefit of priority from Japanese Patent Application No. 2019-189541 filed on Oct. 16, 2019. The entire disclosures of all of the above applications are incorporated herein by reference.

### TECHNICAL FIELD

The present disclosure relates to an inspection device used for inspecting an inspection object.

### BACKGROUND

An inspection device attached to an operator may include a code reader, a camera, and a tablet. The code reader reads a code indicating the type of work to be inspected. The camera takes an image of the work. A microcomputer of the tablet sends an imaging command to the camera in response to that the code reader reads the work code as a trigger. Based on this imaging command, the camera captures an image of the work and acquires the captured image. The microcomputer selects a reference image of the work corresponding to the code read by the code reader from among reference images of a plurality of types of works stored in advance in a memory, and compare the reference image and the captured image of the selected work with each other, so as to determine whether or not the selected work is a non-defective product (i.e., good product). However, in this case, it may be difficult to accurately determine a defective product or non-defective product.

### SUMMARY

An inspection device according to an aspect of the present disclosure is used for inspecting an inspection object to be inspected, and includes an imaging device and a determinator. The imaging device can be attached to an operator to image an imaging range. The determinator is configured to determine a quality of the inspection object. The determinator is configured: to receive image data of the imaging range transmitted from the imaging device; to identify an image area in which the inspection object exists in the image data of the imaging range; to set a predetermined area within the image area in which the inspection object exists, as an inspection area; and to collate the image data of the inspection area with a pre-registered collation image data to determine whether the quality of the inspection object is defective or not. Therefore, it is possible to more accurately determine the quality of the inspection object to be inspected.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram schematically showing a part of a manufacturing process of a first embodiment of the present disclosure;

FIG. 2 is a block diagram showing a configuration of an inspection device according to the first embodiment;

FIG. 3 is a flow diagram showing processing procedures executed respectively by a determinator of a terminal device and an imaging device according to the first embodiment;

FIG. 4 is a schematic diagram showing an example of collation image data of the first embodiment;

FIG. 5 is a schematic diagram showing an example of image data captured by the imaging device of the first embodiment;

FIG. 6 is a schematic diagram showing an example of collation image data according to a second embodiment of the present disclosure;

FIG. 7 is a schematic diagram showing an example of image data captured by an imaging device of the second embodiment;

FIG. 8 is a schematic diagram showing an example of collation image data of a third embodiment of the present disclosure; and

FIG. 9 is a schematic diagram showing an example of image data captured by an imaging device of the third embodiment.

### DESCRIPTION OF EMBODIMENT

An inspection device attached to an operator may include a code reader, a camera, and a tablet. The inspection device can be used, for example, when inspecting whether or not a predetermined part is assembled at an appropriate position of a work. When the inspection device is used in such an inspection, a similar product may be erroneously detected as the inspection object if the similar part similar to the predetermined part is present in the imaging range of the camera. In such a situation, it becomes difficult to appropriately determine the quality of the work.

An object of the present disclosure is to provide an inspection device capable of inspecting an inspection object and to more accurately determine the quality of the inspection object.

An inspection device according to an exemplar of the present disclosure can be used for inspecting an inspection object, and includes an imaging device and a determinator. The imaging device can be attached to an operator to image an imaging range. The determinator is configured to determine a quality of the inspection object. The determinator is configured: to receive image data of the imaging range transmitted from the imaging device; to identify an image area in which the inspection object exists in the image data of the imaging range; to set a predetermined area within the image area in which the inspection object exists, as an inspection area; and to collate the image data of the inspection area with a pre-registered collation image data, to determine whether the quality of the inspection object is defective or not.

According to this configuration, the image data of a non-defective inspection object can be used as the collation image data. In this case, when a predetermined part is assembled to the predetermined area of the inspection object by an operator, it is determined that the inspection object is a non-defective product if collation between the image data of the inspection area and the collation image data is established. If the operator assembles the predetermined part in an area different from the predetermined area of the inspection object, the collation between the image data in the inspection area and the collation image data cannot be established, and thereby, it is determined that the inspection object is a defective product. According to the above configuration, it is possible to easily determine the quality of the inspection object. Further, even when a similar object that is similar to the predetermined part exists in the vicinity of the inspection object, the quality of the inspection object is not determined based on the similar object if the similar object exists at a position outside the inspection area of the inspection object. Therefore, it is possible to more accurately determine the quality of the inspection object to be inspected. The determinator may be configured to determine that the inspection object is a defective product when a collation between the image data of the inspection area and the collation image data is not established.

For example, the determinator may be configured to re-obtain the image data of the imaging range transmitted from the imaging device, if the determinator determines that the inspection object does not exist in the image data of the imaging range after receiving the image data of the imaging range transmitted from the imaging device.

The he inspection area may include a first inspection area and a second inspection area. In this case, the determinator is configured

to set the first inspection area within the image area in which the inspection object exists, and to set the second inspection area within the first inspection area, and

to determine the quality of the inspection object by collating image data of the second inspection area with pre-registered collation image data.

Alternatively, the determinator may be configured to set a plurality of the inspection areas in the image area in which the inspection object exists, and to collate the image data of the plurality of the inspection areas with collation image data to determine the quality of the inspection object.

Hereinafter, an inspection device of the present disclosure will be described with reference to the drawings. In order to facilitate the understanding, the same reference numerals are attached to the same constituent elements in each drawing where possible, and redundant explanations are omitted.

### First Embodiment

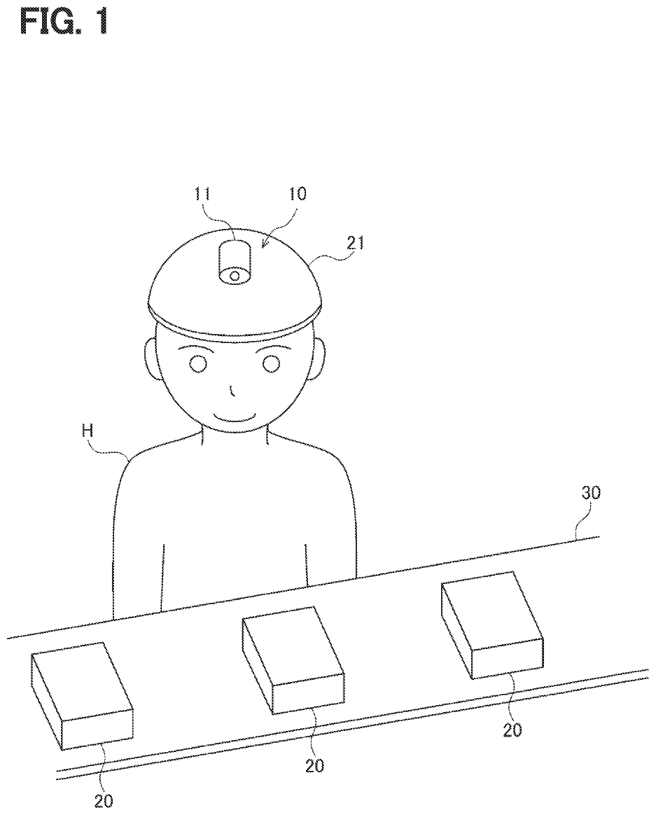

First, an inspection device 10 according to the first embodiment shown in FIG. 1 will be described. The inspection device 10 according to the first embodiment is used in a manufacturing process of a product of any device such as a heat exchanger, an electrical device or the like. Specifically, the inspection device 1 is used in an intermediate manufacturing stage before a finished product, to inspect whether or not an inspection object such as a workpiece 20 is a good product (i.e., non-defective product). Specifically, the workpiece 20 is flowing on a production line while being placed on a conveyor 30. In the vicinity of the conveyor 30, a plurality of operators (e.g., workers) H are lined up along a flow direction of the workpiece 20. When the workpiece 20 is positioned in front of the worker H, the worker H performs an assembling work for assembling a predetermined part or predetermined plural parts at the position of the workpiece 20. At that time, the inspection device 10 inspects and determines whether or not the workpiece 20, to which the predetermined part(s) is assembled, is a non-defective product (good product). The inspection device 10 is a wearable inspection device that can be attached to the worker H, for example. Each worker H sequentially performs the assembly work of predetermined parts so that a finished product is manufactured. In this embodiment, the workpiece 20 is an example of the inspection object (i.e., an object to be inspected).

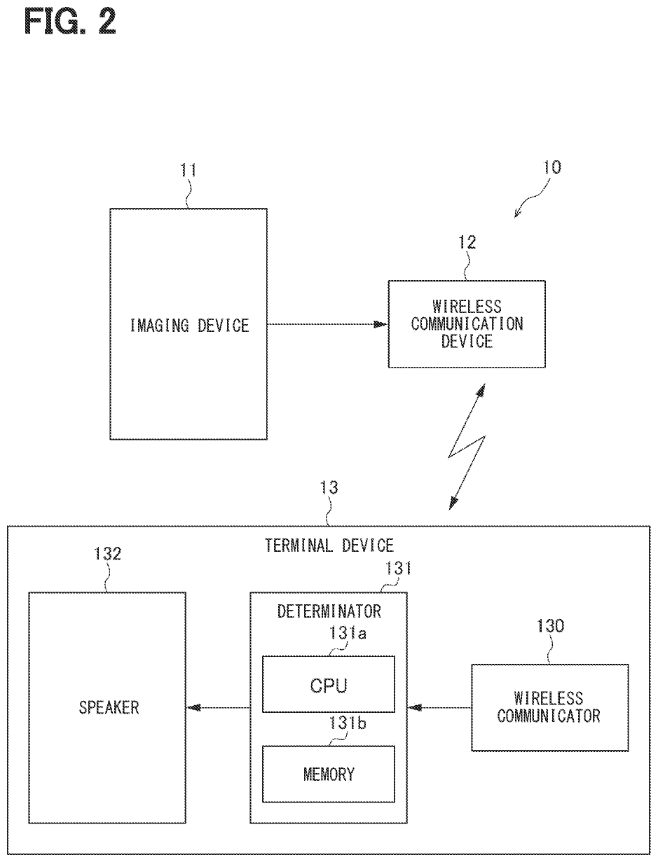

As shown in FIG. 2, the inspection device 10 includes an imaging device 11, a wireless communication device 12, and a terminal device 13. The wireless communication device 12 and the terminal device 13 are not shown in FIG. 1.

As shown in FIG. 1, the imaging device 11 is attached to the worker H to image an imaging range. The imaging device 11 is fixedly attached to a helmet 21 worn on the head of the worker H. The imaging range of the imaging device 11 is set to a predetermined range in the direction in which the face of the worker H is facing, that is, in front of the worker H. When the worker H turns his/her face toward the workpiece 20 in order to assemble a predetermined part to the workpiece 20, the entire workpiece 20 is positioned within the imaging range of the imaging device 11. The imaging device 11 constantly images the imaging range regardless of whether or not the workpiece 20 is present in the imaging range, and transmits the image data of the captured imaging range to the wireless communication device 12 shown in FIG. 2. In the present embodiment, the imaging device 11 corresponds to an example of an image pickup unit such as a camera, a radar or the like.

The wireless communication device 12 is connected to the imaging device 11 by a wire or a wireless communication. The wireless communication device 12 sequentially transmits the image data transmitted from the imaging device 11 to the terminal device 13 by wireless communication.

The terminal device 13 is a portable tablet terminal, a stationary personal computer, or the like. The terminal device 13 determines the quality of the workpiece 20 based on the image data wirelessly transmitted from the imaging device 11 via the wireless communication device 12, and notifies the worker H of the determination result. The terminal device 13 includes a wireless communicator 130, a determinator 131, and a speaker 132.

The wireless communicator 130 receives the image data sequentially transmitted from the wireless communication device 12, and transmits the received image data to the determinator 131.

The determinator 131 is mainly configured by a microcomputer having a CPU 131a, a memory 131b, and the like. The determinator 131 is configured to perform an image process for extracting an image data of the workpiece 20 from the image data in the imaging range by executing a program stored in advance in the memory 131b, and to perform a determination process for determining the quality of the workpiece 20 based on the extracted image data of the workpiece 20. The determinator 131 notifies the speaker 132 of the quality determination result of the workpiece 20 obtained through the determination process. Specifically, when the determinator 131 determines that the workpiece 20 is a non-defective product (good product), the determinator 131 outputs a first sound indicating the non-defective product from the speaker 132. When the determinator 131 determines that the workpiece 20 is a defective product (bad product), the determinator 131 outputs a second sound indicating a defective product from the speaker 132. The first sound and the second sound are different sounds.

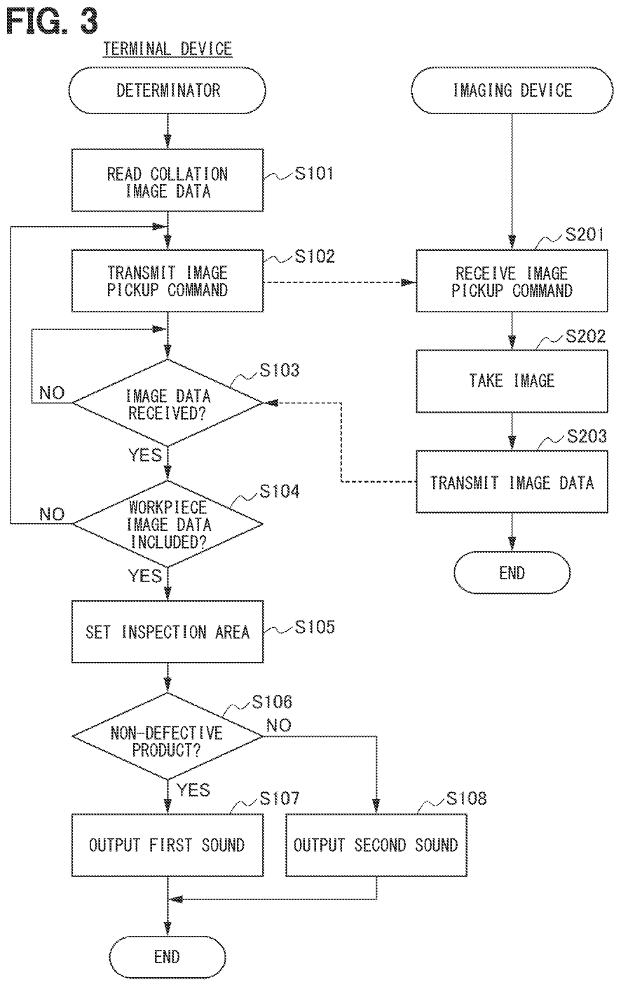

Next, a specific procedure of processes executed by the imaging device 11 and the terminal device 13 will be described. The imaging device 11 and the terminal device 13 repeatedly execute the processes shown in FIG. 3 with a predetermined cycle.

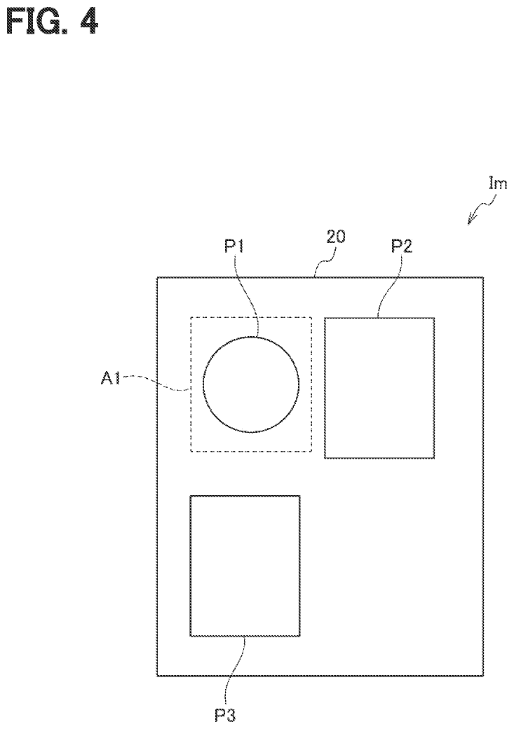

First, the determinator 131 of the terminal device 13 reads a collation image data Im from the memory 131b in the process of step S101. The collation image data Im is image data obtained by imaging a non-defective work in advance, and is, for example, image data as shown in FIG. 4. As shown in FIG. 4, the collation image data Im is the image data of the workpiece 20 in which a plurality of parts P1 to P3 are assembled. The region A1 shown by the broken line in the collation image data Im in FIG. 4 indicates an assembling position of the part P1 on the workpiece 20. The collation image data Im is registered in the memory 131b in advance.

As shown in FIG. 3, the determinator 131 transmits an image pickup command to the imaging device 11 in the process of step S102 following step S101. Then, at the process of step S103, the determinator 131 determines whether image data of the imaging range transmitted from the imaging device 11 is received.

When the imaging device 11 receives the image pickup command transmitted from the determinator 131 of the terminal device 13 in the process of step S201, the imaging device 11 takes an image of the image pickup range at the process of step S202. Then, the imaging device 11 transmits the image data of the imaging range to the terminal device 13 in the process of step S203. Hereinafter, the image data of the imaging range transmitted from the imaging device 11 to the terminal device 13 will be referred to as “image data of the imaging device 11”.

If the determinator 131 of the terminal device 13 has not received the image data of the imaging device 11 after transmitting the image pickup command in the process of step S102, the determinator 131 of the terminal device 13 makes a negative determination in the process of step S103 and continuously performs the determination process at step S103. That is, the determinator 131 monitors whether or not the image data of the imaging device 11 has been received. Then, when the determinator 131 receives the image data of the imaging device 11, the determinator 11 makes a positive determination in the process of step S103, and determines whether or not the image data of the workpiece 20 is included in the image data of the imaging device 11 in the subsequent process of step S104.

Specifically, in the process of step S104, the determinator 131 extracts a feature amount of the image data of the imaging device 11 by performing image processing such as edge detection process with respect to the image data of the imaging device 11. The determinator 131 determines whether or not the feature amount of the extracted image data of the imaging device 11 includes the feature amount of the workpiece 20 of the collation image data Im, so as to determine whether or not the image data of the imaging device 11 includes the image data of the workpiece 20 to be inspected. As the process of comparing the feature amounts, any process such as a pattern matching or an edge shape evaluation or the like can be used.

When the determinator 131 determines that the feature amount of the image data of the imaging device 11 does not include the feature amount of the workpiece 20 of the collation image data Im in the process of step S104, step S104 determines that the image data of the workpiece 20 is not included in the image data of the imaging device 11. In this case, the determinator 131 makes a negative determination in the process of step S104, and returns to the process of step S102. Then, at step S102, the image pickup command is transmitted again from the determinator 131 to the imaging device 11. Therefore, the determinator 131 continuously acquires the image data of the imaging device 11 until the image data of the imaging device 11 includes the image data of the workpiece 20.

Then, when the image data of the workpiece 20 is included in the image data of the imaging device 11, the determinator 131 makes a positive determination in the process of step S104, and an inspection area of the image data is set in the subsequent process of step S105.

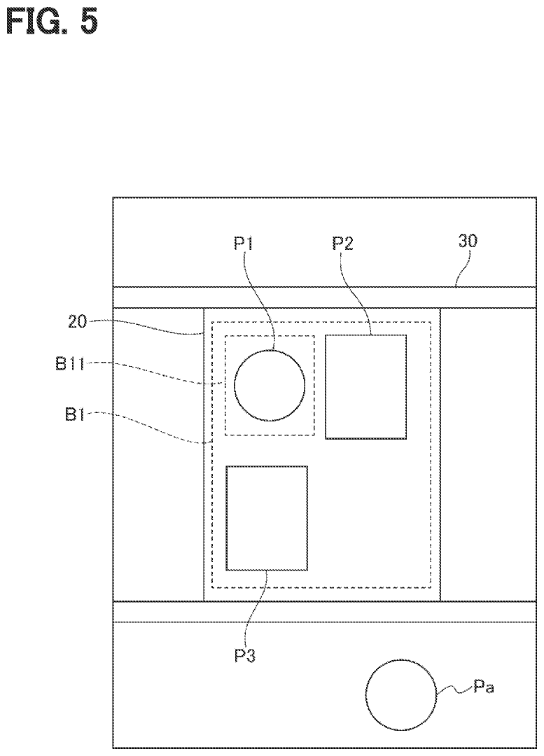

Specifically, in the process of step S105, the determinator 131 compares the feature amount of the image data of the imaging device 11 with the feature amount of the workpiece 20 of the collation image data Im, so that the image area in which the workpiece 20 exists is specified from the image data of the imaging device 11. For example, when the image data shown in FIG. 5 is acquired as the image data of the imaging device 11, the range shown by the broken line B1 in FIG. 5 is specified as the image range in which the workpiece 20 exists. Subsequently, the determinator 131 sets a predetermined area within the image range B1 of the workpiece 20 as an inspection area. For example, when the working process of the worker H is a process of assembling a part P1 to the position A1 of the workpiece 20 shown in FIG. 4, an area B11 corresponding to the position A1 in the image range B1 of the workpiece 20 is set as an inspection area as shown in FIG. 5.

As shown in FIG. 3, the determinator 131 determines whether or not the workpiece 20 is a non-defective product in the process of step S106. Specifically, the determinator 131 extracts the feature amount of the inspection area B11 of the image data in the process of step S106, and determines whether or not the feature amount of the extracted inspection area B11 matches the position A1 of the collation image data Im. As the process of comparing the feature amounts, any process such as a pattern matching or an edge shape evaluation or the like can be used. In the present embodiment, the process of determining whether or not the feature amount of the inspection area B11 matches the feature amount of the position A1 of the collation image data Im corresponds to the collation process for collating the image data of the inspection area and the collation image data.

When the worker H properly assembles the part P1 at the position A1 of the workpiece 20, the feature amount of the inspection area B11 and the feature amount of the collation image data Im at the position A1 come to match. In this case, the collation between the image data of the inspection area B11 and the collation image data Im is established. Thus, the determinator 131 makes the positive determination in the process of step S106, that is, determines that the workpiece 20 is a non-defective product, and causes the speaker 132 to output the first sound indicating that the workpiece 20 is a non-defective product in the process of step S107. Based on the first sound output from the speaker 132, the worker H can know that his/her work has been properly completed.

In contrast, for example, when the worker H assembles the part P1 at a position different from the position A1 of the workpiece 20, the feature amount of the inspection area B11 and the feature amount of the collation image data Im at the position A1 do not match from each other. In this case, the collation between the image data in the inspection area B11 and the collation image data Im is not established. Thus, the determinator 131 makes the negative determination in the process of step S106, that is, determines that the workpiece 20 is a defective product, and causes the speaker 132 to output the second sound indicating that the workpiece 20 is a defective product in the process of step S108. Based on the second sound output from the speaker 132, the worker H can know that the workpiece 20 is a defective product.

According to the inspection device 10 of this embodiment described above, operations and effects described in the following (i) to (iii) can be obtained.
(i) As shown in FIG. 5, even in a case where a similar part Pa that is similar to the part P1 exists in the vicinity of the workpiece 20, the quality of the workpiece 20 is not determined based on the similar product Pa if the similar part Pa exists at a position outside the inspection area B11 of the workpiece 20. Therefore, it is possible to more accurately determine the quality of the workpiece 20.
(ii) The determinator 131 acquires again the image data of the imaging device 11 by re-transmitting the image pickup command to the imaging device 11, if the workpiece 20 does not exist in the image data of the imaging device 11 after the determinator 131 obtains the image data of the imaging device 11. According to this configuration, it is possible to continuously determine the quality of the workpiece 20 without requiring the worker H to perform any operation.
(iii) When the collation between the image data in the inspection area B11 and the collation image data Im is not established, the determinator 131 determines that the workpiece 20 is a defective product. According to this configuration, it is possible to easily determine whether or not the workpiece 20 is a defective product.

### Second Embodiment

Next, an inspection device 10 of the second embodiment will be described. Hereinafter, differences from the inspection device 10 of the first embodiment will be mainly described.

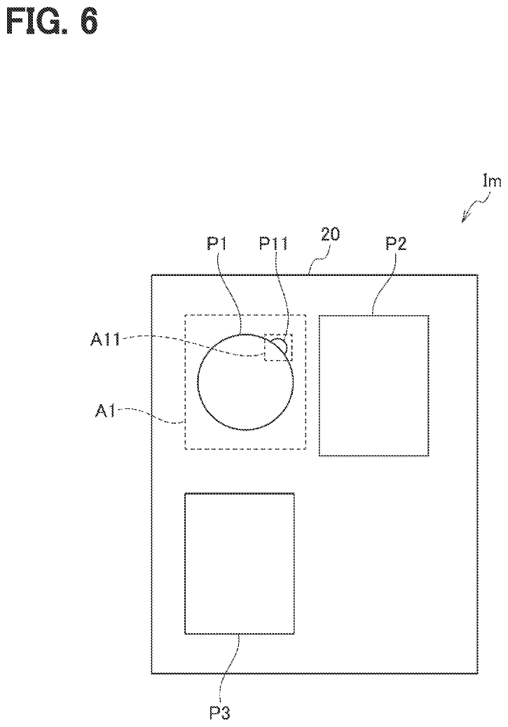

As shown in FIG. 6, a work of assembling a part P1 to the position A1 of the workpiece 20 and then a work of further assembling a part P11 to the position A11 of the part P1 may be combined as the work of the worker H, for example. In the inspection device 10 of the present embodiment, the image data of the workpiece 20 shown in FIG. 6 is used as a collation image data Im.

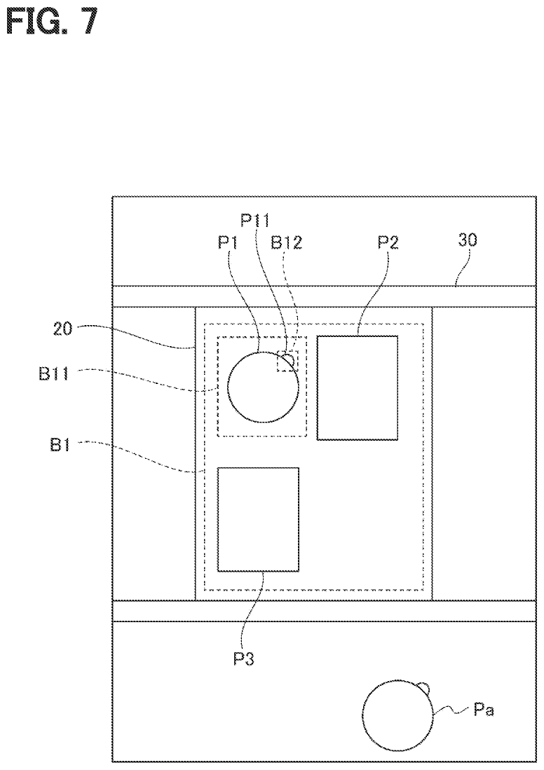

As shown in FIG. 7, the determinator 131 of the terminal device 13 of the present embodiment sets a first inspection area B11 within the image range B1 of the workpiece 20, and then further sets a second inspection area B12 within the first inspection area B11. In the present embodiment, the first inspection area B11 corresponds to an inspection area of the part P1, and the second inspection area B12 corresponds to an inspection area of the part P11. When the determinator 131 determines that the feature amount of the first inspection area B11 and the feature amount of the collation image data Im at the position A1 match from each other, it is further determined whether or not the feature amount of the second inspection area B12 matches the feature amount of the collation image data Im at the position A11 shown in FIG. 6. When the determinator 131 determines that the feature amount of the second inspection area B12 matches the feature amount of the collation image data Im at the position A11, the determinator 131 determines that the workpiece 20 is a non-defective product (i.e., good product).

According to the inspection device 10 of this embodiment described above, operations and effects described in the following (iv) can be further obtained in addition to the above (i) to (iii) of the first embodiment.
(iv) The determinator 131 of the terminal device 13 of the present embodiment sets the first inspection area B11 within the image range B1 in which the workpiece 20 exists, and then further sets the second inspection area B12 within the first inspection area B11. The determinator 131 determines the quality of the workpiece 20 by collating the image data of the second inspection area B12 with the collation image data Im. According to this configuration, since the details of the workpiece 20 can be inspected, it is possible to determine the quality of the workpiece 20 in detail.

### Third Embodiment

Next, an inspection device 10 of the third embodiment will be described. Hereinafter, differences from the inspection device 10 of the first embodiment will be mainly described.

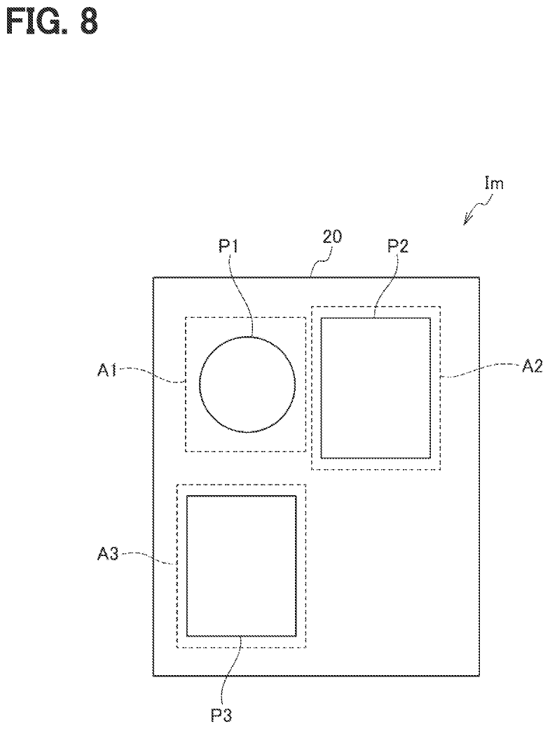

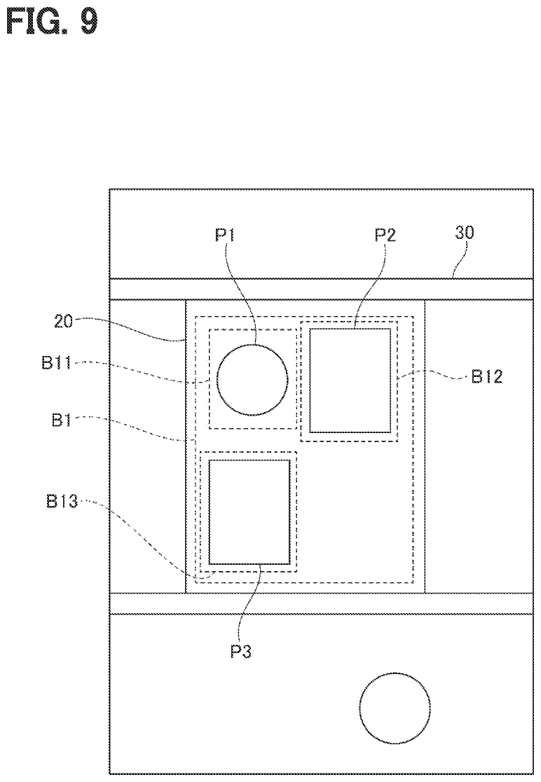

As the work of the worker H, a work of assembling all of plural parts (e.g., three parts) P1 to P3 shown in FIG. 8 to the workpiece 20 can be considered. As shown in FIG. 9, the determinator 131 of the terminal device 13 of the present embodiment sets three inspection areas B11 to B13 within the image range B1 of the workpiece 20, and then the quality of the workpiece 20 is determined by collating the image data of the inspection areas B11 to B13 with the collation image data Im.

According to the inspection device 10 of this embodiment described above, operations and effects described in the following (v) can be further obtained in addition to the above (i) to (iii) of the first embodiment.
(v) Since a plurality of the inspection areas B11 to B13 are set in the image range B1 of the workpiece 20, it is possible to accurately determine the quality of the workpiece 20 even when an operator performs the work of assembling the plurality of parts P1 to P3 to the workpiece 20.

### OTHER EMBODIMENTS

The preceding embodiments may be practiced in the following modes.

In the process of step S106 shown in FIG. 3, the determinator 131 may perform the process of comparing and collating the image data of the inspection area with the collation image data by a plurality of times.

The process of comparing and collating the feature amount of the image data of the imaging device 11 with the feature amount of the collation image data Im is not limited to the process such as the pattern matching or the edge shape evaluation, but a determination such as color determination or dimension determination may be used. Alternatively, it is possible to use a determination method of learning image data using AI or the like.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. Each element included in each of the specific examples described above can be appropriately combined together as long as there is no technical contradiction.

What is claimed is:

1. An inspection device used for inspecting an inspection object to be inspected, the inspection device comprising:
an imaging device attached to an operator to image an imaging range; and
a determinator configured to determine whether a quality of the inspection object is defective, wherein
the determinator is configured
to receive image data of the imaging range transmitted from the imaging device,
to identify an image area in which the inspection object exists in the image data of the imaging range,
to set a predetermined area within the image area in which the inspection object exists, as an inspection area, and
to collate the image data of the inspection area with pre-registered collation image data to determine whether the quality of the inspection object is defective or not.

2. The inspection device according to claim 1, wherein
the determinator is configured to re-obtain the image data of the imaging range transmitted from the imaging device, if the determinator determines that the inspection object does not exist in the image data of the imaging range after receiving the image data of the imaging range transmitted from the imaging device.

3. The inspection device according to claim 1, wherein
the determinator is configured to determine that the inspection object is a defective product when a collation between the image data of the inspection area and the collation image data is not established.

4. The inspection device according to claim 1, wherein
the inspection area includes a first inspection area and a second inspection area, and
the determinator is configured
to set the first inspection area within the image area in which the inspection object exists, and to set the second inspection area within the first inspection area, and
to determine the quality of the inspection object by collating image data of the second inspection area with pre-registered collation image data.

5. The inspection device according to claim 1, wherein
the determinator is configured
to set a plurality of the inspection areas in the image area in which the inspection object exists, and
to collate the image data of the plurality of the inspection areas with collation image data to determine the quality of the inspection object.
